(19) United States
(12) Patent Application Publication
(10) Pub. No.: US 2016/0224617 A1
(43) Pub. Date: Aug. 4, 2016

(54) SYSTEM AND METHOD FOR PROVIDING SEARCH SERVICE USING TAGS

(71) Applicant: NAVER Corporation, Seongnam-si (KR)

(72) Inventors: Jinah Jeong, Seongnam-si (KR); Tae Ho Lee, Seongnam-si (KR)

(21) Appl. No.: 15/015,969

(22) Filed: Feb. 4, 2016

(30) Foreign Application Priority Data
Feb. 4, 2015 (KR) 10-2015-0017524

(51) Int. Cl. G06F 17/30

(52) U.S. Cl. CPC G06F 17/30395; G06F 17/30392; G06F 17/30477

(57) ABSTRACT

A method of providing a search service includes searching for a keyword from attribute information about a search word input from a user and a user generated content (UGC) document, and extracting one or more tags based on the retrieved keyword, outputting a search result in response to the search word, and displaying the extracted one or more tags on a result screen with the search result, and conducting a re-search by adding the selected tag to the search word, in response to a selection of the user on at least one selected among the displayed tags.

### CROSS-REFERENCE TO RELATED APPLICATION(S)

This application claims priority under 35 U.S.C. §119 to Korean Patent Application No. 10-2015-0017524 filed on Feb. 4, 2015, in the Korean Intellectual Property Office (KIPO), the entire contents of which are incorporated herein by reference.

### BACKGROUND

1. Field

One or more example embodiments of the present invention relate to a search service, and more particularly, to a method and a system for conducting a search by adding a tag to a search word.

2. Description of Related Art

This section provides background information related to the present disclosure which is not necessarily prior art.

A search service refers to software or a website that helps a user search for information on the Internet. Such a search engine extracts a search result about a search word input from the user and provides the extracted search result to the user.

However, when the search service provides a search result depending on matching with a search word input from a user, a search result unsuitable for the search intent of the user may be provided. Thus, a relatively large amount of time is used for the user to conduct an information search.

Accordingly, a method of using a tag is employed to configure the search service. The tag refers to a keyword or classification information assigned as metadata to specific source information, for example, information that is an entity of search. One or more tags may be set to each set of source information. The tag enables the user to easily connect to corresponding information and thus, facilitates search, display, classification, etc., of source information.

### SUMMARY

This section provides a general summary of the disclosure, and is not a comprehensive disclosure of its full scope or all of its features.

A search service providing system according to example embodiments may provide a method that may provide a tag about a search word input from a user.

A search service providing system according to example embodiments may provide a search result suitable for the intent of a user by conducting a re-search using a search word and a tag.

According to an aspect, there is provided a method of providing a search service, the method including searching for a keyword from attribute information about a search word input from a user and a user generated content (UGC) document, and extracting one or more tags based on the retrieved keyword, outputting a search result in response to the search word, and displaying the extracted one or more tags on a result screen including the search result, and conducting a re-search by, in response to a selection of the user on at least one tag among the displayed tags, adding the selected tag to the search word.

The extracting may include classifying and maintaining keyword information based on a preset category criterion, extracting the keyword from the UGC document or a search collection based on the keyword information, and providing a tag corresponding to the search result by normalizing the extracted keyword.

The outputting and the displaying may include extracting a tag from each of a plurality of search words in response to the plurality of search words being input from the user, and displaying the extracted tag on a tag area corresponding to each of the search words.

The outputting and the displaying may include providing a plurality of display methods for displaying the tag extracted from each of the search words.

The outputting and the displaying may include providing search results about the plurality of search words for comparison using a tag about a first search word and a tag about a second search word, in response to the plurality of search words input from the user being included in the same category attribute.

The conducting of the re-search may include providing the user with a user interface for selecting the at least one tag, and adding and displaying the tag selected through the user interface on a search box on which the search word is displayed.

The conducting of the re-search may include filtering the search result corresponding to the search word using the selected tag, and outputting a re-search result including a result corresponding to the selected tag.

The conducting of the re-search may include sorting and displaying the re-search result acquired through filtering using the selected tag, based on a preset criterion.

According to another aspect, there is provided a non-transitory computer-readable recording medium storing instructions for controlling a computer system to provide a search service, wherein the instructions control the computer system by a search service proving method including searching for a keyword from attribute information about a search word input from a user and a UGC document, and extracting one or more tags based on the retrieved keyword, outputting a search result in response to the search word, and displaying the extracted one or more tags on a result screen including the search result, and conducting a re-search by, in response to a selection of the user on at least one tag among the displayed tags, adding the selected tag to the search word.

According to still another aspect, there is provided a system for providing a search service, the system including a tag extractor configured to search for a keyword from attribute information about a search word input from a user and a UGC document, and to extract one or more tags based on the retrieved keyword, a tag displayer configured to output a search result in response to the search word, and to display the extracted one or more tags on a result screen including the search result, and a re-search conductor configured to conduct a re-search by, in response to a selection of the user on at least one tag among the displayed tags, adding the selected tag to the search word.

The tag extractor may be further configured to classify and maintain keyword information based on a preset category criterion, to extract the keyword from the UGC document or a search collection based on the keyword information, and to provide a tag corresponding to the search result by normalizing the extracted keyword.

The tag displayer may be further configured to extract a tag from each of a plurality of search words in response to the plurality of search words being input from the user, and to display the extracted tag on a tag area corresponding to each of the search words.

The tag displayer may be further configured to provide a plurality of display methods for displaying the tag extracted from each of the search words.

The tag displayer may be further configured to provide search results about the plurality of search words for comparison using a tag about a first search word and a tag about a second search word, in response to the plurality of search words input from the user being included in the same category attribute.

The re-search conductor may be further configured to provide the user with a user interface for selecting the at least one tag, and to add and display the tag selected through the user interface on a search box on which the search word is displayed.

The re-search conductor may be further configured to filter the search result corresponding to the search word using the selected tag and to output a re-search result including a result corresponding to the selected tag.

The re-search conductor may be further configured to sort and display the re-search result acquired through filtering using the selected tag, based on a preset criterion.

According to example embodiments, since a search service providing system may summarize a search result using a tag in advance and display the summarized search result on a result search, a user may verify summarized information about the search result.

Also, according to example embodiments, when a tag about a search word is selected by a user, a search service providing system may provide a search result suitable for the intent of the user by performing filtering using the selected tag. Accordingly, the user may acquire the accurate search result further quickly.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Exemplary embodiments of the present invention will be described in more detail with regard to the figures, wherein like reference numerals refer to like parts throughout the various figures unless otherwise specified, and wherein:

FIG. 1 illustrates a relationship between a search service providing system and a user terminal according to an exemplary embodiment;

FIG. 2 is a block diagram illustrating a configuration of the search service providing system shown in FIG. 1 according to one embodiment;

FIG. 3 illustrates an example of a process of extracting a tag at a search service providing system according to an exemplary embodiment;

FIG. 4 illustrates an example of a method of extracting a tag at a search service providing system according to an exemplary embodiment;

FIG. 5 illustrates an example of a process of conducting a re-search by adding a selected tag to a retrieved search word at a search service providing system according to an exemplary embodiment;

FIGS. 6A and 6B illustrate examples of displaying a tag at a search service providing system according to exemplary embodiments;

FIG. 7 is a flowchart illustrating a search service providing method performed at a search service providing system according to an exemplary embodiment; and

FIG. 8 is a block diagram illustrating an example of a configuration of a computer system according to one embodiment.

It should be noted that these figures are intended to illustrate the general characteristics of methods and/or structure utilized in certain exemplary embodiments and to supplement the written description provided below. These drawings are not, however, to scale and may not precisely reflect the precise structural or performance characteristics of any given embodiment, and should not be interpreted as defining or limiting the range of values or properties encompassed by exemplary embodiments.

### DETAILED DESCRIPTION

One or more exemplary embodiments will be described in detail with reference to the accompanying drawings. Exemplary embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, exemplary embodiments will be described with reference to the accompanying drawings.

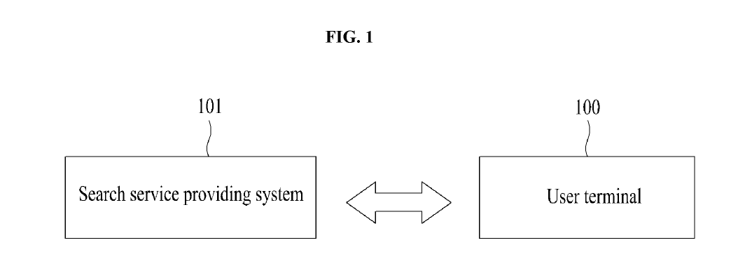

FIG. 1 illustrates a relationship between a search service providing system and a user terminal according to one embodiment.

FIG. 1 illustrates a user terminal 100 and a search service providing system 101. In FIG. 1, an indicator with arrowheads may indicate that data may be transmitted and received between the user terminal 100 and the search service providing system 101 over a wireless network.

The user terminal 100 may refer to a personal computer (PC), a smartphone, a tablet, a wearable computer, and the like, and may refer to any type of terminal devices capable of connecting to a website/mobile site associated with the search service providing system 101, or installing and executing a service exclusive application. Here, the user terminal 100 may perform the overall service operation, such as a service screen configuration, a data input, a data transmission and reception, a data storage, or the like, under the control of the website/mobile site or the exclusive application.

The search service providing system 101 serves as a service platform to provide a search service to a client. That is, the search service providing system 101 may search for a keyword from an attribute of a search word and a user generated content (UGC) document in response to the search word input through the user terminal 100, and may extract a tag based on the retrieved keyword. The search service providing system 101 may display a search result about the keyword and the extracted tag on a result screen.

The search service providing system 101 may be configured in an application form on the user terminal 100, however, without being limited thereto, may be configured to be included in a service platform that provides a priori service in a client-server environment.

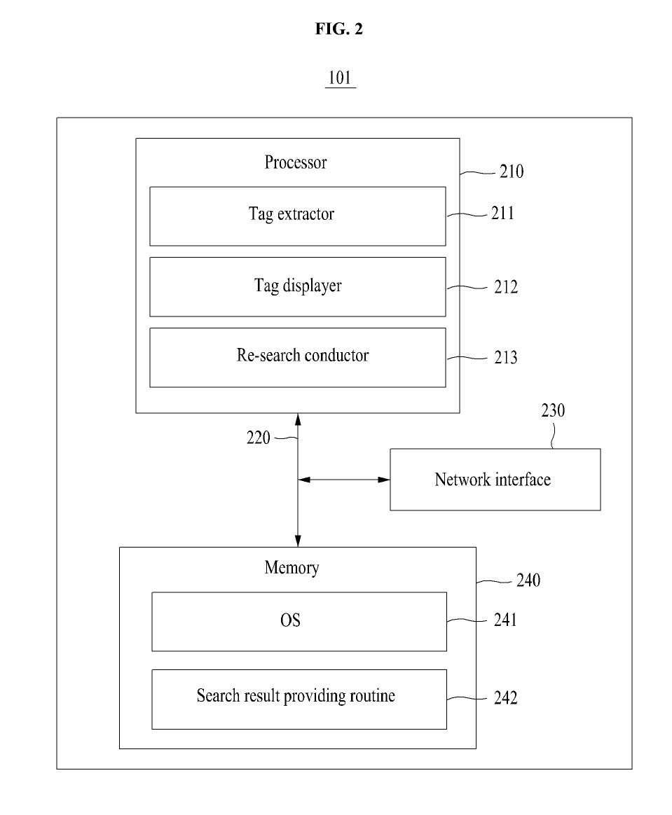

FIG. 2 is a block diagram illustrating a configuration of a search service providing system according to an exemplary embodiment.

Referring to FIG. 2, the search service providing system 101 includes a processor 210, a bus 220, a network interface 230, and a memory 240. The memory 240 includes an operating system (OS) 241 and a search result providing routine 242. The processor 210 performs the functions of a tag extractor 211, a tag displayer 212, and a re-search conductor 213. According to other embodiments, the search service providing system 101 may include a greater or lesser number of constituent elements that the number of constituent elements shown in FIG. 2.

The search service providing system 101 configured as above is provided on the user terminal 100 that is an entity using a search service, and provides a search service environment including a search function to the user terminal corresponding to a client in interaction with a service server in a client-server environment.

The memory 240 may include a permanent mass storage device, such as a random access memory (RAM), a read only memory (ROM), a disc drive, a solid state drive, an optical drive, etc., as a computer-readable storage medium. Also, program codes (e.g., computer readable instructions) for the OS 241, the search result providing routine 242, the computer readable instructions associated with the tag extractor 211, the tag displayer 212, and/or the re-search conductor 213, etc., may be stored in the memory 240. Such software constituent elements may be loaded from another computer-readable storage medium separate from the memory 240 using a drive mechanism (not shown). Other computer-readable storage mediums may include, for example, a floppy drive, a disc, a tape, a DVD/CD-ROM drive, a memory card, etc. Software constituent elements may be loaded to the memory 240 through the network interface 230 instead of, or in addition to, the computer-readable storage medium.

The bus 220 enables communication and data transmission between the constituent elements of the search service providing system 201. The bus 220 may be configured using a high-speed serial bus, a parallel bus, a storage area network (SAN), and/or another appropriate communication technology.

The network interface 230 may be a computer hardware constituent element for connecting the search service providing system 101 to the computer network. The network interface 230 may connect the search service providing system 101 to the computer network through a wireless and/or wired connection.

The processor 210 may be configured to process computer-readable instructions of a computer program by performing basic arithmetic operations, logic operations, and input/output operations of the search service providing system 101. The computer-readable instructions may be provided from the memory 240 and/or the network interface 230 to the processor 210 through the bus 220. The processor 210 is also configured to execute program codes for the tag extractor 211, the tag displayer 212, and/or the re-search conductor 213. The program codes may be stored in a storage device such as the memory 240, for example, the search result providing routine 242.

The tag extractor 211 searches for a keyword from attribute information about a search word input from a user and a user generated content (UGC) document, and may extract one or more tags based on the retrieved keyword. For example, the tag extractor 211 may classify and maintain keyword information based on a preset category criterion, and may extract the keyword from the UGC document or a search collection based on the keyword information. Here, the tag extractor 211 may provide a tag corresponding to the search result by normalizing the extracted keyword. A normalization may indicate a process for displaying a tag by classifying the extracted keyword based on a preset criterion.

The tag displayer 212 outputs a search result in response to the search word, and may display the extracted one or more tags on a result screen with the search result. The tag displayer 212 may extract a tag from each of a plurality of search words in response to the plurality of search words being input from the user, and may display the extracted tag on a tag area corresponding to each of the search words. The tag displayer 212 may display the extracted tag on the tag area in response to the extraction of the tag by the tag extractor 211, the tag being related to the plurality of search words inputted by the user. Here, the tag displayer 212 may provide a plurality of display methods for displaying the tag extracted from each of the search words. The tag displayer 212 may provide search results relating to the plurality of search words for comparison using a tag corresponding to a first search word and a tag corresponding to a second search word, in response to the plurality of search words input from the user being included in the same category attribute.

In response to a selection of the user on at least one tag among the displayed tags, the re-search conductor 213 may conduct a re-search by adding the selected tag to the search word. The re-search conductor 213 may filter the search result corresponding to the search word using the selected tag and may output a re-search result including a result corresponding to the selected tag.

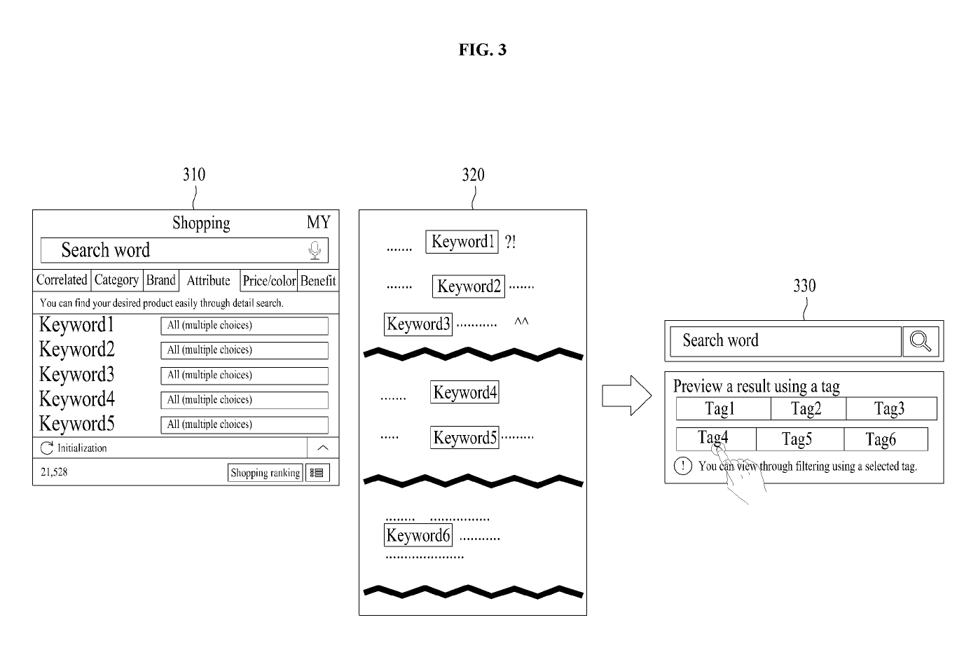

FIG. 3 illustrates an example of a process of extracting a tag at a search service providing system 101 according to exemplary embodiment.

The search service providing system 101 may search for a keyword from attribute information relating to a search word and a UGC document, in response to the search word being input from a user through the user terminal 100. Here, it is assumed that the user inputs the search word at a search service, for example, an Internet portal site through the user terminal 100. For example, when the user searches for “mirror-less” at the Internet portal site, the search service providing system 101 may display a search result 310 about “mirror-less” on a result screen for displaying the search result.

The tag extractor 211 searches for a keyword from the search result 310 about “mirror-less”, for example, keywords 320 such as blogs, cafes, postings, etc., and may extract one or more tags 330 based on the retrieved keyword. Here, the keyword may be extracted based on a correlated word, an index word, a hash tag, keyword information, and the like. Also, the keyword may be found by inputting a search word at various services that are provided at the search service and the tag may be output together with the search result 310. For example, when the user searches for “mirror-less” at a shopping search service provided at the Internet portal site, attribute information about “mirror-less” may be output. For example, attribute information about “mirror-less”, such as the size of a sensor, pixels, a storage medium, and a screen size, and the like, may be output. In this case, the tag extractor 211 may search for a keyword from attribute information about the search word.

The tag displayer 212 may output a search result in response to a search word through the search service, and may display one or more tags, for example, tag 1, tag 2, tag 3, . . . , on the result screen including the search result. For example, a tag about “mirror-less” may include “good photo quality”, “light”, “high sensitivity and low noise”, “vivid color”, “sensor like DSLR”, “small and compact”, etc. Here, a meaningful expression associated with the search word may be extracted as a tag and provided.

According to exemplary embodiments, a user may summarize a search result through a tag that is provided from the search service providing system 101 and may acquire further accurate information by filtering the search result suitable for the intent of the user.

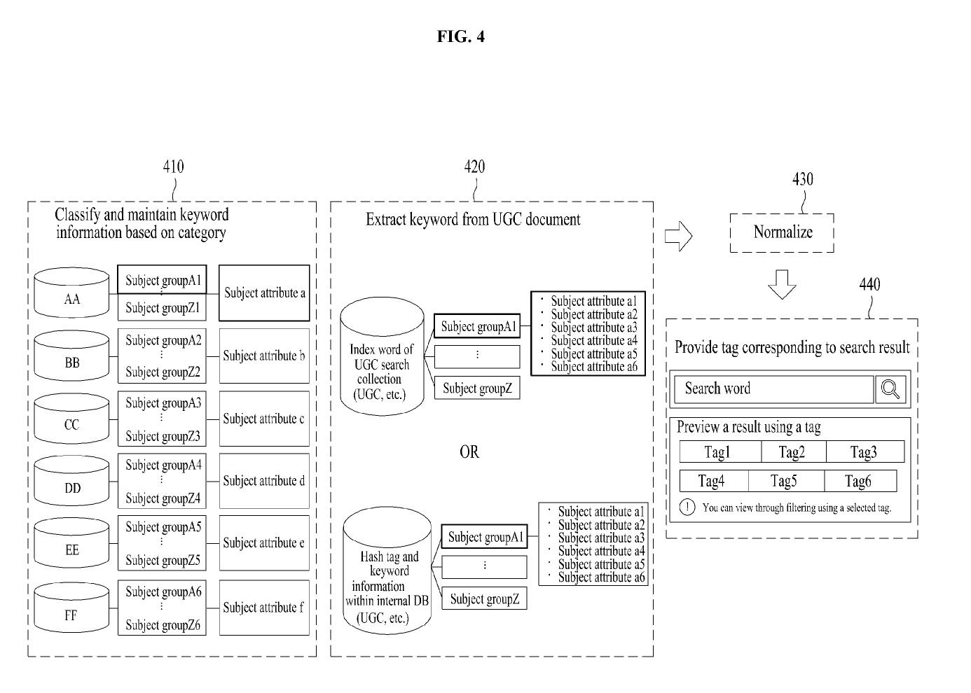

FIG. 4 illustrates an example of a method of extracting a tag at a search service providing system 101 according to an exemplary embodiments.

Without being limited to the tag extraction method of FIG. 4, the tag extractor 211 may extract a tag using a variety of methods.

The tag extractor 211 searches for a keyword from attribute information relating to a search word input from a user and a UGC document, and may extract one or more tags based on the retrieved keyword. UGC may indicate content registered in such a manner that the user posts writing to a blog, a café, a bulletin board, and the like. For example, the user may register writing to a café of an Internet portal site, and the writing registered by the user may be output and provided as information to other users in response to a search word input at the Internet portal site.

In operation 410, the tag extractor 211 classifies and maintains keyword information based on a preset category criterion. For example, the tag extractor 211 may categorize keyword information into digital electronics, home electronics, beauty, accommodations and restaurants, home and furniture, clothing and accessories, etc. Further, the tag extractor 211 may classify a subject group for each category and may classify and store a subject attribute of the subject group. For example, a category of a camera in digital electronics may be classified into a subject group, such as a film camera, mirror-less, DSLR, etc. Attribute information may be stored using durability, power consumption level, price, image quality, weight, etc., about the subject group “mirror-less”.

In operation 420, the tag extractor 211 extracts the keyword from the UGC document or a search collection based on the keyword information. In response to the search word input from the user, the search service providing system extracts a keyword from the UGC document. For example, the tag extractor 211 may extract a keyword based on an index word of a UGC search collection or keyword information and a hash tag within an internal database, etc. Here, each of the UGC search collection and the internal database may classify a keyword into a subject group and may store a subject attribute about the subject group. The tag extractor 211 normalizes the extracted keyword in operation 430 and the tag displayer 212 provides a tag corresponding to the search result in operation 440. For example, the tag displayer 212 may sort and display, using tags, keywords in order in which the keywords are frequently extracted from the UGC document and may display a tag among the tags to apply a keyword frequently selected by the user.

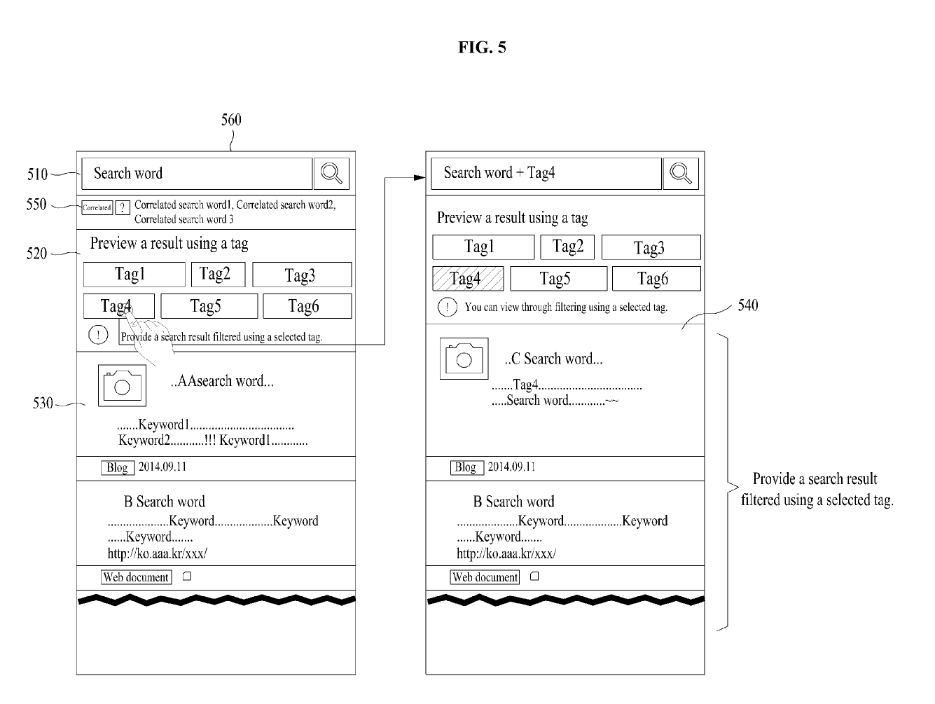

FIG. 5 illustrates an example of a process of conducting a re-search by adding a selected tag to a retrieved search result at a search service providing system 101 according to example embodiments.

As described above with FIG. 3, a user may enter a search word into a search service, for example, a search box 510 of an Internet portal site through a user terminal 100. The tag extractor 211 may search for a keyword from attribute information relating to the input search word and a UGC document and may extract a tag based on the retried keyword.

In response to the search word, the tag displayer 212 displays a search result 530 on a result screen 560. Here, the tag displayer 212 displays the search result 530 and a tag area 520 for displaying the extracted tags. Here, one or more tags may be displayed on the tag area 520 based on the search word. Also, the tag displayer 212 may further display a correlated search word area 550 for displaying a correlated search word associated with the search word.

In response to a selection of the user on at least one tag among the displayed tags, the re-search conductor 213 conducts a re-search by adding the selected tag to the search word. Here, the re-search conductor 213 provides an interface that enables the user to select a tag. When the tag is selected through the interface, the tag may be added to the search box 510 and displayed together with the search word. The search service providing system 101 filters the search result using the selected tag and displays a re-search result 540 including a result corresponding to the selected tag.

In an example in which a search word is “mirror-less”, the tag displayer 212 may display tags about “mirror-less”, such as “good photo quality”, “light”, “high sensitivity and low noise”, “vivid color”, “sensor like DSLR”, “small and compact”, etc., using the tag extraction method of FIG. 4. The user may select at least one tag from among the displayed tags. The re-search conductor 213 may conduct a re-search by adding the selected tag, for example, “vivid color” to the search box 510. The search service providing system may display the re-search result 540 on the result screen in response to the re-search about “mirror-less”+“vivid color”. The re-search conductor 213 may display a search result including “mirror-less” and “vivid color”. In this example, the re-research result 540 to which the search word and the tag are added, for example, the search result including “mirror-less” and “vivid color” may be output based on a preset criterion. For example, the re-search result 540 may be displayed so that keywords corresponding to the tag are sorted in order of keywords that are frequently used in the UGC document, or may be displayed based on a preset criterion such as timestamp.

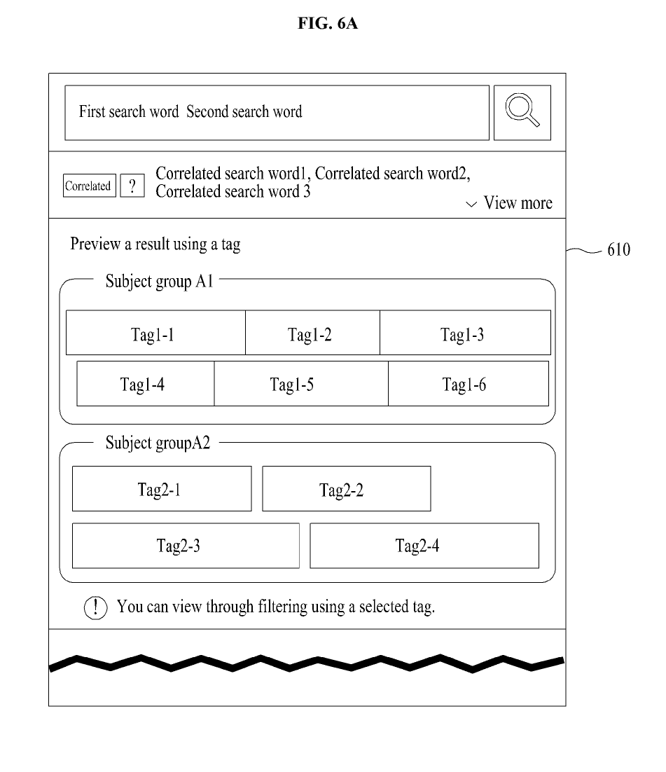

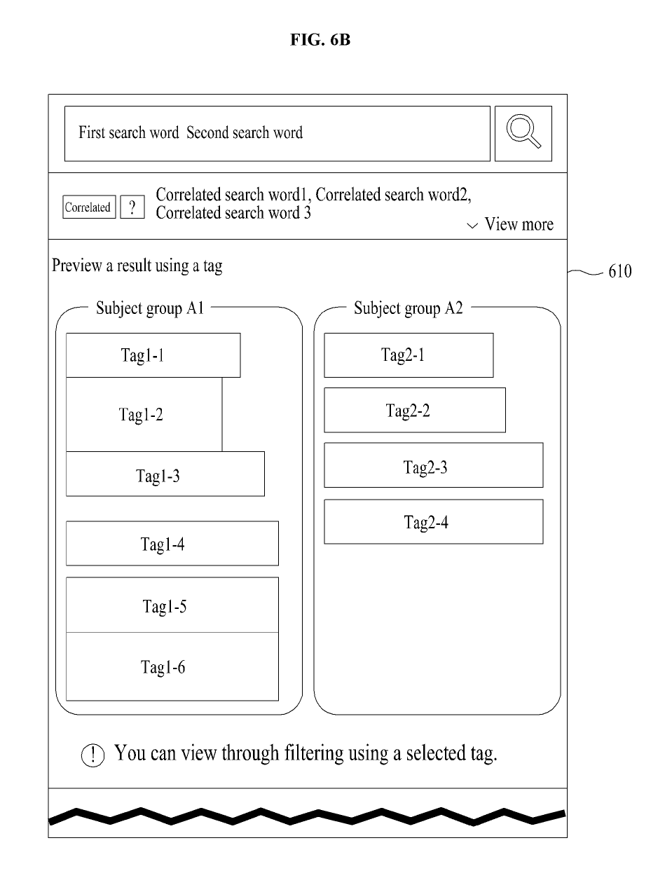

FIGS. 6A and 6B illustrate examples of displaying a tag at a search service providing system 101 according to an exemplary embodiment.

In response to a plurality of search words being input from a user, the tag extractor 211 extracts a tag from each of the search words and the tag displayer 212 displays the extracted tags on a tag area 610 corresponding to each of the search words. The tag displayer 212 may employ a plurality of methods for displaying a tag extracted from each search word. For example, The tag displayer 212 may display tags as illustrated in FIGS. 6A and 6B, and may also display the tags using a variety of methods. Also, the user may display the tags in a desired manner.

In response to the plurality of search words being input from the user, the tag extractor 211 may extract a tag from each of the search words and the tag displayer 212 may display the extracted tag in a tag area 610 corresponding to each of the search words.

In response to the plurality of search words input from the user being included in the same category attribute, the tag displayer 212 may provide search results relating to the plurality of search words for comparison using a tag relating to a first search word and a tag relating to a second search word.

The tag displayer 212 may display a tag extracted from a search word on a corresponding tag area. The tag displayer 212 may display extracted tags to be horizontally listed on tag areas corresponding to the respective search words as shown in FIG. 6A and may display the extracted tags to be vertically listed on tag areas corresponding to the respective search words as shown in FIG. 6B.

When the user is to conduct a search on a camera, types of the camera may include, for example, a digital camera, a mirror-less camera, a DSLR camera, a film camera, etc. In an example in which the user conducts a search on “mirror-less DSLR”, the tag extractor 211 may extract a tag about “mirror-less” and a tag about “DSLR” and may display the tag about “mirror-less” on a mirror-less tag area and the tag about “DSLR” on a DSLR tag area. The tag displayer 212 may display a search result about “mirror-less DSLR” on a result screen and may further display the tag about “mirror-less” and the tag about “DSLR” on the result screen. If the search result is output as shown in FIG. 6A, tags about “mirror-less”, such as good photo quality”, “light”, “high sensitivity and low noise”, “vivid color”, “sensor like DSLR”, “small and compact”, etc., would be horizontally displayed on the mirror-less tag area, and tags about “DSLR”, such as “good out-focus”, “high sensitivity and low noise”, “suitable for night photographing”, “various lens compatibility”, etc., would be horizontally displayed on the DSLR tag area. If the search result is output as shown in FIG. 6B, tags about “mirror-less”, such as good photo quality”, “light”, “high sensitivity and low noise”, “vivid color”, “sensor like DSLR”, “small and compact”, etc., would be vertically displayed on the mirror-less tag area, and tags about “DSLR”, such as “good out-focus”, “high sensitivity and low noise”, “suitable for night photographing”, “various lens compatibility”, etc., would be vertically displayed on the DSLR tag area.

According to exemplary embodiments, the tag displayer 212 may display an extracted tag in a corresponding tag area and the user may verify a summarized search result through the tag.

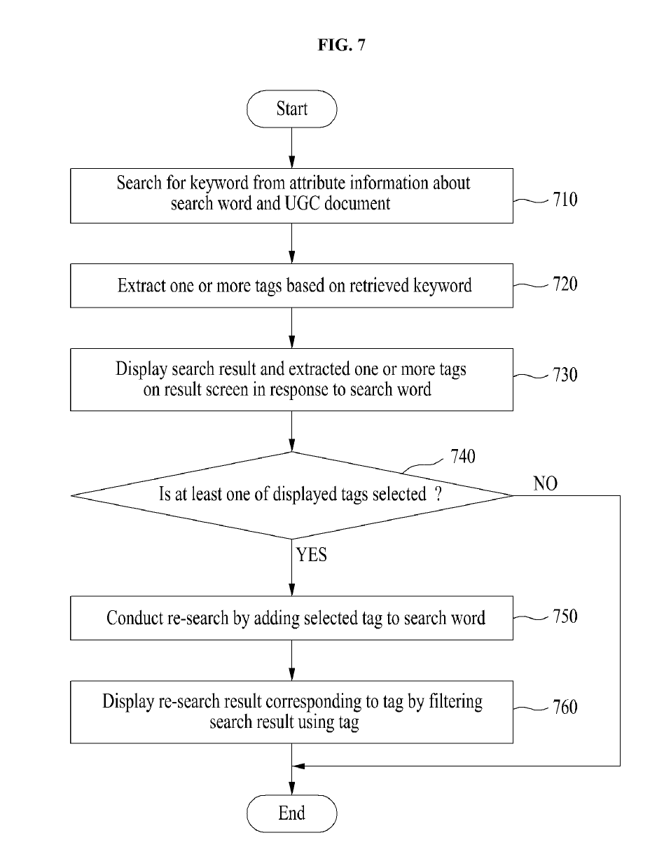

FIG. 7 is a flowchart illustrating a search service providing method performed at a search service providing system 101 according to an exemplary embodiment.

Referring to FIG. 7, the search service providing system 101 searches for, and retrieves, a keyword from attribute information about a search word input from a user and a UGC document in operation 710, and extracts one or more tags based on the retrieved keyword in operation 720.

In operation 730, the search service providing system 101 displays a search result and the extracted one or more tags on a result screen in response to the search word.

In operation 740, the search service providing system 101 determines whether at least one tag is selected by the user from among the displayed tags. Here, in response to the selection of the user of at least one tag, the search service providing system 101 conducts a re-search by adding the selected tag to the search word in operation 750. Here, the search service providing system 101 may additionally display the selected tag on a search box on which the search word is displayed.

In operation 760, the search service providing system 101 displays a re-search result corresponding to the tag by filtering the search result using the tag. The re-search result displayed by the search service providing system 101 may include the search word input from the user and the tag selected by the user.

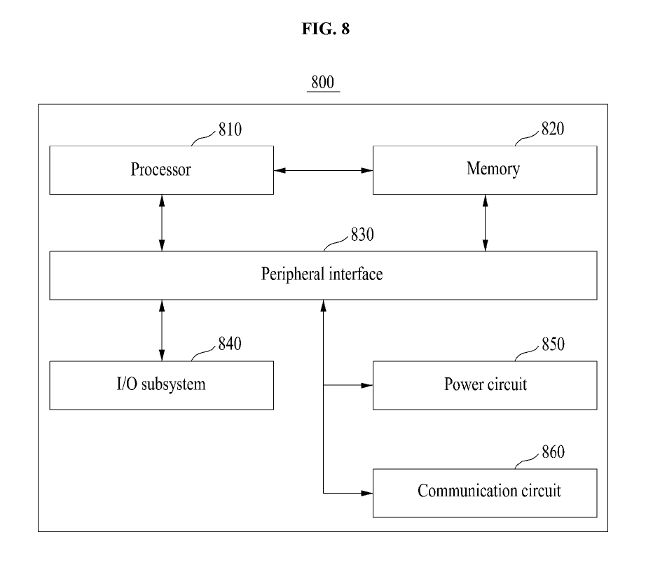

FIG. 8 is a block diagram illustrating an example of a configuration of a computer system according to one embodiment.

Referring to FIG. 8, a computer system 800 includes at least one processor 810, a memory 820, a peripheral interface 830, an input/output (I/O) subsystem 840, a power circuit 850, and a communication circuit 860. The computer system 800 may correspond to the user terminal 100.

The memory 820 may include, for example, a high-speed random access memory (HSRAM), a magnetic disk, a static random access memory (SRAM), a dynamic RAM (DRAM), read only memory (ROM), a flash memory, and a non-volatile memory. The memory 820 may include a software module, an instruction set, or a variety of data required for an operation of the computer system 800. Here, an access from another component such as the processor 810 and the peripheral interface 830 to the memory 820 may be controlled by the processor 810.

The peripheral interface 830 couples an input device and/or output device of the computer system 800 with the processor 810 and the memory 820. The processor 810 performs a variety of functions for the computer system 800 and process data by executing the software module or the instruction set stored in the memory 820.

The I/O subsystem 840 couples various I/O peripheral devices with the peripheral interface 830. For example, the I/O subsystem 840 may include a controller for coupling the peripheral interface 830 and a peripheral device such as a monitor, a keyboard, a mouse, a printer, and a touch screen or a sensor depending on a necessity. The I/O peripheral devices may be coupled with the peripheral interface 830 without using the I/O subsystem 840.

The power circuit 850 supplies power to all of or a portion of components of the computer system 800. For example, the power circuit 850 may include a power management system, at least one power source such as a battery and alternating circuit (AC), a charge system, a power failure detection circuit, a power converter or inverter, a power status indicator, or other components for creating, managing and distributing power.

The communication circuit 860 enables communication with another computer system using at least one external port. Alternatively, the communication circuit 860 may enable communication with another computer system by including a radio frequency (RF) circuit and thereby transmitting and receiving an RF signal known as an electromagnetic signal.

The embodiment of FIG. 8 is only an example of the computer system 800. The computer system 800 may have a configuration or an arrangement for omitting a portion of the components illustrated in FIG. 8, further including components not illustrated in FIG. 8, or coupling two or more components. For example, a computer system for a communication terminal of a mobile environment may further include a touch screen, a sensor, and the like, in addition to the components of FIG. 8. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 860. Components includable in the computer system 800 may be configured as hardware that includes an integrated circuit specified for at least one signal processing or application, software, or a combination of hardware and software.

The methods according to exemplary embodiments may be configured in a program instruction form executable through a variety of computer systems and thereby recorded in non-transitory computer-readable media. In particular, the program according to the example embodiments may be configured as a PC-based program or an application exclusive for a mobile terminal. Also, the application may be installed in a user terminal through a file provided from the file distribution system. For example, the file distribution system may include a file transmitter (not shown) to transmit the file in response to a request from the user terminal.

As described above, according to exemplary embodiments, since the search service providing system 101 displays a tag about a search word input from a user, the user may approximately verify summary information about a search result. Further, the search service providing system 101 may conduct a re-search by adding the tag to the search word and provide a search service so that the user may further easily and quickly achieve a desired search result.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of providing a search service, the method comprising:
searching, by a processor, for a keyword from attribute information relating to a search word input from a user and a user generated content (UGC) document, and extracting one or more tags based on the retrieved keyword;
outputting, by a processor, a search result in response to the search word, and displaying the extracted one or more tags on a result screen with the search result; and
conducting, by a processor, a re-search by adding the selected tag to the search word, in response to a selection of the user of at least one tag among the one or more displayed tags.

2. The method of claim 1, wherein the extracting comprises:
classifying and maintaining keyword information based on a preset category criterion;
extracting the keyword from the UGC document or a search collection based on the keyword information; and
providing the one or more tags corresponding to the search result by normalizing the extracted keyword.

3. The method of claim 1, wherein the outputting and the displaying comprises:
extracting a tag from each of a plurality of search words in response to the plurality of search words being input from the user, and displaying the extracted tag on a tag area corresponding to each of the search words.

4. The method of claim 3, wherein the outputting and the displaying comprises:
displaying the tag extracted from each of the search words in one of a plurality of display methods.

5. The method of claim 3, wherein the outputting and the displaying comprises:
providing search results about the plurality of search words for comparison using a tag about a first search word and a tag about a second search word, in response to the plurality of search words input from the user being included in the same category attribute.

6. The method of claim 1, wherein the conducting of the re-search comprises:
providing the user with a user interface for selecting the at least one tag, and adding and displaying the tag selected through the user interface in a search box in which the search word is displayed.

7. The method of claim 6, wherein the conducting of the re-search comprises:
filtering the search result corresponding to the search word using the selected tag, and outputting a re-search result including a result corresponding to the selected tag.

8. The method of claim 7, wherein the conducting of the re-search comprises:
sorting and displaying the re-search result acquired through filtering using the selected tag, based on a preset criterion.

9. A non-transitory computer-readable recording medium storing instructions for controlling a computer system to provide a search service, wherein the instructions control the computer system to perform the steps comprising:
searching for a keyword from attribute information relating to a search word input from a user and a user generated content (UGC) document, and extracting one or more tags based on the retrieved keyword;
outputting a search result in response to the search word, and displaying the extracted one or more tags on a result screen with the search result; and
conducting a re-search by adding the selected tag to the search word, in response to a selection of the user of at least one tag among the one or more displayed tags.

10. A system in communication with a user terminal for providing a search service, the system comprising:
a tag extractor configured to search for a keyword from attribute information relating a search word input from a user through the user terminal and a user generated content (UGC) document, and to extract one or more tags based on the retrieved keyword;
a tag displayer configured to output a search result in response to the search word, and to display the extracted one or more tags on a result screen with the search result; and
a re-search conductor configured to conduct a re-search by adding the selected tag to the search word, in response to a selection of the user of at least one tag among the one or more displayed tags.

11. The system of claim 10, wherein the tag extractor is further configured to classify and maintain keyword information based on a preset category criterion, to extract the keyword from the UGC document or a search collection based on the keyword information, and to provide the one more tags corresponding to the search result by normalizing the extracted keyword.

12. The system of claim 10, wherein the tag displayer is further configured to extract a tag from each of a plurality of search words in response to the plurality of search words being input from the user, and to display the extracted tag on a tag area corresponding to each of the search words.

13. The system of claim 12, wherein the tag displayer is further configured to display the tag extracted from each of the search words in a plurality of display methods.

14. The system of claim 12, wherein the tag displayer is further configured to provide search results about the plurality of search words for comparison using a tag relating to a first search word and a tag relating to a second search word, in response to the plurality of search words input from the user being included in the same category attribute.

15. The system of claim 10, wherein the re-search conductor is further configured to provide the user with a user interface for selecting the at least one tag, and to add and display the tag selected through the user interface in a search box of the user terminal in which the search word is displayed.

16. The system of claim 15, wherein the re-search conductor is further configured to filter the search result corresponding to the search word using the selected tag and to output a re-search result including a result corresponding to the selected tag.

17. The system of claim 16, wherein the re-search conductor is further configured to sort and display the re-search result acquired through filtering using the selected tag, based on a preset criterion.
